(19) United States
(12) Patent Application Publication
(10) Pub. No.: US 2011/0250378 A1
(43) Pub. Date: Oct. 13, 2011

(54) PATTERNED SPUNBOND FIBROUS WEBS AND METHODS OF MAKING AND USING THE SAME

(76) Inventors: Bradley W. Eaton, Woodbury, MN (US); Michael R. Berrigan, Oakdale, MN (US); John D. Stelter, Hudson, WI (US); Timothy J. Diekmann, Maplewood, MN (US)

(21) Appl. No.: 13/140,448

(22) PCT Filed: Dec. 10, 2009
(86) PCT No.: PCT/US09/67464

§ 371 Date: Jun. 17, 2011

Related U.S. Application Data
(60) Provisional application No. 61/140,412, filed on Dec. 23, 2008.

(51) Int. Cl. B32B 3/06; D04H 5/00; B32B 5/00; D04H 3/16

(52) U.S. Cl. 428/99; 442/401; 442/334; 156/178

(57) ABSTRACT

Patterned spunbond fibrous webs include a population of spunbond filaments captured in an identifiable pattern corresponding to a patterned collector surface and bonded together without the use of an adhesive prior to removal from the collector surface. The webs may exhibit a high degree of filament orientation and/or a gradient of filament density in one or more directions determined by the patterned collector surface. Methods of making patterned spunbond fibrous webs, and articles including patterned spunbond fibrous webs made according to the methods, are also disclosed. In exemplary applications, the webs may be used in gas filtration articles, liquid filtration articles, sound absorption articles, surface cleaning articles, cellular growth support articles, drug delivery articles, personal hygiene articles, or wound dressing articles.

### CROSS REFERENCE TO RELATED APPLICATION

This application claims the benefit of U.S. Provisional Patent Application No. 61/140,412, filed Dec. 23, 2008, the disclosure of which is incorporated by reference herein in its entirety.

### TECHNICAL FIELD

The present disclosure relates to patterned nonwoven fibrous webs and methods of making and using such webs. The disclosure further relates to patterned nonwoven fibrous webs include a population of spunbond filaments captured in an identifiable pattern and bonded together without the use of an adhesive.

### BACKGROUND

Nonwoven webs have been used to produce a variety of absorbent articles useful, for example, as absorbent wipes for surface cleaning, as wound dressings, as gas and liquid absorbent or filtration media, and as barrier materials for sound absorption. In some applications, it may be desirable to use a shaped nonwoven web. For example, U.S. Pat. Nos. 5,575,874 and 5,643,653 (Griesbach, III et al.) disclose shaped nonwoven fabrics and methods of making such shaped nonwoven webs. In other applications, it may be desirable to use a nonwoven web having a textured surface, for example, as a nonwoven fabric in which the filaments are pattern bonded with an adhesive binder material, as described in U.S. Pat. No. 6,093,665 (Sayovitz et al.); or in which a meltblown fiber layer is formed on a patterning belt and subsequently laminated between two spunbond filament layers.

U.S. Pat. No. 5,858,515 (Stokes), U.S. Pat. No. 6,921,570 (Belau), and U.S. Pub. No. 2003/0119404 (Belau) describe lamination methods, some of which include use of patterned nip rollers, for producing structured multi-layer nonwoven webs from two or more meltblown fiber webs. The use of a patterned belt to form a structured web from discontinuous fibers has also been used in meltblown processes, for example, as described in U.S. Pat. No. 4,103,058 (Humlicek). However, the meltblown process differs from the spunbond process in that meltblown fibers are not truly continuous, as are the filaments formed by melt spinning.

Although some methods of forming shaped or textured nonwoven webs are known, the art continually seeks new methods of forming nonwoven webs, particularly nonwoven webs having a patterned or textured surface and including a population of continuous filaments.

### SUMMARY

In one aspect, the disclosure relates to a fibrous web including a population of spunbond filaments captured in an identifiable pattern determined by a patterned collector surface and bonded together without the use of an adhesive prior to removal from the patterned collector surface. In some exemplary embodiments, the population of spunbond filaments comprises (co)polymeric filaments. In certain exemplary embodiments, the (co)polymeric filaments comprise polypropylene, polyethylene, polyester, polyethylene terephthalate, polybutylene terephthalate, polyamide, polyurethane, polybutene, polylactic acid, polyvinyl alcohol, polyphenylene sulfide, polysulfone, liquid crystalline polymer, polyethylene-co-vinylacetate, polyacrylonitrile, cyclic polyolefin, polyoxymethylene, polyolefinic thermoplastic elastomers, or a combination thereof. In particular exemplary embodiments, the (co)polymeric filaments comprise polyolefin filaments. In further exemplary embodiments, the population of spunbond filaments has a median filament diameter ranging from about 1 μm to about 100 μm.

In a related aspect, the disclosure relates to fibrous webs including a population of spunbond filaments collected in an identifiable pattern and bonded together without an adhesive, wherein at least a portion of the filaments are oriented in a direction determined by the pattern. In some exemplary embodiments related to both aspects, the identifiable pattern is a two-dimensional pattern. In certain exemplary embodiments, the two-dimensional pattern is an arrangement of geometric shapes selected from the group consisting of circles, ovals, polygons, X-shapes, V-shapes, and combinations thereof. In some particular exemplary embodiments, the arrangement of geometric shapes is a two-dimensional array.

In another related aspect, the disclosure relates to a method of making a fibrous web, comprising forming a plurality of filaments with a spunbonding process, capturing a population of the filaments in an identifiable pattern on a patterned collector surface, and bonding at least a portion of the filaments together without the use of an adhesive prior to removal of the web from the patterned collector surface, thereby causing the fibrous web to retain the identifiable pattern. In some exemplary embodiments, the method further comprises attenuating at least some of the filaments before capturing the population of the filaments on the patterned collector surface. In certain exemplary embodiments, bonding comprises one or more of autogenous thermal bonding, non-autogenous thermal bonding, and ultrasonic bonding. In particular exemplary embodiments, at least a portion of the filaments is oriented in a direction determined by the pattern.

In further exemplary embodiments, the patterned collector surface comprises a plurality of geometrically shaped perforations extending through the collector, and capturing the population of filaments comprises drawing a vacuum through the perforated patterned collector surface. In some exemplary embodiments, the plurality of geometrically shaped perforations have a shape selected from the group consisting of circular, oval, polygonal, X-shape, V-shape, and combinations thereof. In some particular exemplary embodiments, the plurality of geometrically shaped perforations have a polygonal shape selected from the group consisting of triangular, square, rectangular, trapezoidal, pentagonal, hexagonal, octagonal, and combinations thereof. In additional exemplary embodiments, the plurality of geometrically shaped perforations comprises a two-dimensional pattern on the patterned collector surface. In particular exemplary embodiments, the two-dimensional pattern of geometrically shaped perforations on the patterned collector surface is a two-dimensional array.

In yet another aspect, the disclosure relates to articles comprising the composite nonwoven fibrous webs described above prepared according to the foregoing methods. Certain particular exemplary articles may be useful as a gas filtration article, a liquid filtration article, a sound absorption article, a thermal insulation article, a surface cleaning article, an abrasive article, a cellular growth support article, a drug delivery article, a personal hygiene article, and a wound dressing article.

Various aspects and advantages of exemplary embodiments of the presently disclosed invention have been summarized. The above Summary is not intended to describe each illustrated embodiment or every implementation of the presently disclosed invention. The Drawings and the Detailed Description that follow more particularly exemplify certain preferred embodiments using the principles disclosed herein.

### BRIEF DESCRIPTION OF THE DRAWINGS

Exemplary embodiments of the present disclosure are further described with reference to the appended figures, wherein:

FIG. 1 is a schematic overall diagram of an exemplary apparatus for forming a patterned spunbond fibrous web according to certain illustrative embodiments of the present disclosure.

FIGS. 2A-2F are top views of various exemplary perforated patterned collector surfaces useful in forming a patterned spunbond fibrous web according to certain illustrative embodiments of the present disclosure.

FIG. 3 is an enlarged side view of an exemplary optional processing chamber for attenuating filaments useful in forming a patterned spunbond fibrous web according to certain illustrative embodiments of the present disclosure, with mounting means for the chamber not shown.

FIG. 4 is a top view, partially schematic, of the exemplary optional processing chamber shown in FIG. 3 together with mounting and other associated apparatus.

FIG. 5 is a schematic enlarged and expanded view of an optional heat-treating part of the exemplary apparatus shown in FIG. 1.

FIG. 6 is a perspective view of the apparatus of FIG. 5, showing an exemplary perforated patterned collector according to FIG. 2B, useful for forming a patterned spunbond fibrous web according to an illustrative embodiment of the present disclosure

FIGS. 7A-7D are photographs of the surfaces of various exemplary patterned spunbond fibrous web according to certain illustrative embodiments of the present disclosure.

FIG. 7E is a micrograph of an exemplary patterned spunbond fibrous web showing filaments oriented in a direction determined by the pattern of FIG. 2A according to an illustrative embodiment of the present disclosure.

### DETAILED DESCRIPTION

### Glossary

As used herein:

“Fiber is used to denote a discontinuous or discrete elongate strand of material.

“Filament” is used to denote a continuous elongate strand of material.

“Microfilament” refers to a population of filaments having a population median diameter of at least one micrometer.

“Ultrafine Microfilament” refers to a population of filaments having a population median diameter of two micrometers or less.

“Sub-micrometer Filament” refers to a population of filaments having a population median diameter of less than one micrometer.

When reference is made herein to a batch, group, array, layer, etc. of a particular kind of microfilament, e.g., “a layer of microfilaments,” it means the complete population of spunbond filaments in that layer, or the complete population of a single batch of spunbond filaments, and not only that portion of the layer or batch that is of sub-micrometer dimensions.

“Oriented filaments” as used herein to refer to a population of filaments refers to filaments arranged or collected so that at least the longitudinal axes of two or more of the filaments are aligned in the same direction (“oriented” as used with respect to a single filament means that at least portions of the molecules of the filaments are aligned along the longitudinal axis of the filaments).

“Meltblown” or “Melt-blown” herein refers to fibers prepared by extruding molten fiber-forming material through orifices in a die into a high-velocity gaseous stream, wherein the extruded material is first attenuated and then solidifies as a mass of fibers.

“Spunbond” or “Spun-bond” herein refers to filaments prepared by extruding molten filament-forming material through orifices in a die into a low-velocity, optionally heated, gaseous stream, which then solidify as a mass of thermally-bonded filaments.

“Autogenous bonding” is defined as bonding between filaments at an elevated temperature as obtained in an oven or with a through-air bonder without application of direct contact pressure such as in point-bonding or calendering.

“Molecularly same” polymer refers to polymers that have essentially the same repeating molecular unit, but which may differ in molecular weight, method of manufacture, commercial form, etc.

“Self supporting” or “self sustaining” in describing a web means that the web can be held, handled and processed by itself.

“Web Basis Weight” is calculated from the weight of a 10 cm×10 cm web sample.

“Web Thickness” is measured on a 10 cm×10 cm web sample using a thickness testing gauge having a tester foot with dimensions of 5 cm×12.5 cm at an applied pressure of 150 Pa.

“Bulk Density” is the bulk density of the polymer or polymer blend that makes up the web, taken from the literature.

Various exemplary embodiments of the disclosure will now be described with particular reference to the Drawings. Exemplary embodiments of the presently disclosed invention may take on various modifications and alterations without departing from the spirit and scope of the disclosure. Accordingly, it is to be understood that the embodiments of the presently disclosed invention are not to be limited to the following described exemplary embodiments, but is to be controlled by the limitations set forth in the claims and any equivalents thereof.

### A. Patterned Spunbond Fibrous Webs

Patterned spunbond nonwoven fibrous webs having a two- or three-dimensional structured surface may be formed by capturing melt spun filaments on a patterned collector surface and bonding the filaments without an adhesive while on the collector, for example, by thermally bonding the filaments on the collector under a through-air bonder. Although non-patterned spunbond webs having a generally random orientation of filaments and a substantially flat or non-textured surface are known, for example, as described in U.S. Pat. No. 6,916,752 (Berrigan et al.), conventional spunbond webs cannot achieve the patterned effect, nor retain any identifiable pattern formed on a collector surface, as the conventional spunbond filaments are generally not bonded into a structurally stable web until after removal from the collector surface and passing through a calendering operation.

The present disclosure, in some embodiments, relates to a fibrous web including a population of spunbond filaments captured in an identifiable pattern determined by a patterned collector surface and bonded together without the use of an adhesive prior to removal from the patterned collector surface.

1. Filament Component

In some exemplary embodiments, the population of spunbond filaments comprises (co)polymeric filaments. In certain exemplary embodiments, the (co)polymeric filaments comprise polypropylene, polyethylene, polyester, polyethylene terephthalate, polybutylene terephthalate, polyamide, polyurethane, polybutene, polylactic acid, polyvinyl alcohol, polyphenylene sulfide, polysulfone, liquid crystalline polymer, polyethylene-co-vinylacetate, polyacrylonitrile, cyclic polyolefin, polyoxymethylene, polyolefinic thermoplastic elastomers, or a combination thereof. In particular exemplary embodiments, the (co)polymeric filaments comprise polyolefin filaments. In further exemplary embodiments, the population of spunbond filaments has a median filament diameter ranging from about 1 μm to about 100 μm.

In a related aspect, the disclosure relates to fibrous webs including a population of spunbond filaments collected in an identifiable pattern and bonded together without an adhesive, wherein at least a portion of the filaments are oriented in a direction determined by the pattern. In some exemplary embodiments, the identifiable pattern is a two-dimensional pattern. In certain exemplary embodiments, the two-dimensional pattern is an arrangement of geometric shapes selected from the group consisting of circles, ovals, polygons, X-shapes, V-shapes, and combinations thereof. In some particular exemplary embodiments, the arrangement of geometric shapes is a two-dimensional array.

The patterned spunbond fibrous webs of the present disclosure comprise one or more filament components such as microfilament component, an ultrafine microfilament component, and/or a sub-micrometer fiber component. In some embodiments, a preferred filament component is a microfilament component comprising filaments having a median filament diameter of at least about 1 μm. In certain embodiments, a preferred filament component is a microfilament component comprising filaments having a median filament diameter of at most about 200 μm. In some exemplary embodiments, the microfilament component comprises filaments have a median filament diameter ranging from about 1 μm to about 100 μm. In other exemplary embodiments, the microfilament component comprises filaments have a median filament diameter ranging from about 5 μm to about 75 μm, or even about 10 μm to about 50 μm. In certain particularly preferred embodiments, the microfilament component comprises filaments have a median filament diameter ranging from about 15 μm to about 30 μm.

In the present disclosure, the “median filament diameter” of filaments in a given microfilament component is determined by producing one or more images of the filament structure, such as by using a scanning electron microscope; measuring the filament diameter of clearly visible filaments in the one or more images resulting in a total number of filament diameters, x; and calculating the median filament diameter of the x filament diameters. Typically, x is greater than about 50, and desirably ranges from about 50 to about 200. Preferably, the standard deviation about the median filament diameter is at most about 2 micrometers, more preferably at most about 1.5 micrometers, most preferably at most about 1 micrometer.

In some exemplary embodiments, the microfilament component may comprise one or more polymeric materials. Generally, any filament-forming polymeric material may be used in preparing the microfilament, though usually and preferably the filament-forming material is semi-crystalline. The polymers commonly used in filament formation, such as polyethylene, polypropylene, polyethylene terephthalate, nylon, and urethanes, are especially useful. Webs have also been prepared from amorphous polymers such as polystyrene. The specific polymers listed here are examples only, and a wide variety of other polymeric or filament-forming materials are useful.

Suitable polymeric materials include, but are not limited to, polyolefins such as polypropylene and polyethylene; polyesters such as polyethylene terephthalate and polybutylene terephthalate; polyamide (Nylon-6 and Nylon-6,6); polyurethanes; polybutene; polylactic acids; polyvinyl alcohol; polyphenylene sulfide; polysulfone; liquid crystalline polymers; polyethylene-co-vinylacetate; polyacrylonitrile; cyclic polyolefins; polyoxymethylene; polyolefinic thermoplastic elastomers; or a combination thereof.

A variety of natural filament-forming materials may also be made into nonwoven spunbond filaments according to exemplary embodiments of the present disclosure. Preferred natural materials may include bitumen or pitch (e.g., for making carbon filaments). The filament-forming material can be in molten form or carried in a suitable solvent. Reactive monomers can also be employed, and reacted with one another as they pass to or through the die. The nonwoven webs may contain a mixture of filaments in a single layer (made for example, using two closely spaced die cavities sharing a common die tip), a plurality of layers (made for example, using a plurality of die cavities arranged in a stack), or one or more layers of multi-component filaments (such as those described in U.S. Pat. No. 6,057,256 to Krueger et al.).

Filaments also may be formed from blends of materials, including materials into which certain additives have been blended, such as pigments or dyes. Bi-component spunbond filaments, such as core-sheath or side-by-side bi-component filaments, may be prepared (“bi-component” herein includes filaments with two or more components, each component occupying a part of the cross-sectional area of the filament and extending over a substantial length of the filament), as may be bicomponent sub-micrometer filaments. However, exemplary embodiments of the disclosure may be particularly useful and advantageous with monocomponent filaments (in which the filaments have essentially the same composition across their cross-section, but “monocomponent” includes blends or additive-containing materials, in which a continuous phase of substantially uniform composition extends across the cross-section and over the length of the filament). Among other benefits, the ability to use single-component filaments reduces complexity of manufacturing and places fewer limitations on use of the web.

In addition to the filament-forming materials mentioned above, various additives may be added to the filament melt and extruded to incorporate the additive into the filament. Typically, the amount of additives is less than about 25 wt %, desirably, up to about 5.0 wt %, based on a total weight of the filament. Suitable additives include, but are not limited to, particulates, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluorochemicals.

One or more of the above-described additives may be used to reduce the weight and/or cost of the resulting filament and layer, adjust viscosity, or modify the thermal properties of the filament or confer a range of physical properties derived from the physical property activity of the additive including electrical, optical, density-related, liquid barrier or adhesive tack related properties.

2. Optional Additional Layers

The patterned spunbond fibrous webs of the present disclosure may comprise additional layers in combination with the microfilament component (alone or with an ultrafine microfilament component and/or a sub-micrometer filament component), the support layer, or both. One or more additional layers may be present over and/or under an outer surface of the spunbond filament web.

Suitable additional layers include, but are not limited to, a color-containing layer (e.g., a print layer); any of the above-described support layers; one or more additional sub-micrometer filament components having a distinct average filament diameter and/or physical composition; one or more secondary fine sub-micrometer filament layers for additional insulation performance (such as a melt-blown web or a fiberglass fabric); foams; layers of particles; foil layers; films; decorative fabric layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof.

3. Optional Attachment Devices

In certain exemplary embodiments, the patterned spunbond fibrous webs of the present disclosure may further comprise one or more attachment devices to enable the patterned spunbond fibrous article to be attached to a substrate. As discussed above, an adhesive may be used to attach the patterned spunbond fibrous article. In addition to adhesives, other attachment devices may be used. Suitable attachment devices include, but are not limited to, any mechanical fastener such as screws, nails, clips, staples, stitching, thread, hook and loop materials, etc. Additional attachment methods include thermal bonding of the surfaces, for example, by application of heat or using ultrasonic welding or cold pressure welding.

The one or more attachment devices may be used to attach the patterned spunbond fibrous article to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); a surface of a pipe or hose; a computer or electronic component; a sound recording or reproduction device; a housing or case for an appliance, computer, etc.

### B. Methods of Making Patterned Spunbond Fibrous Webs

The present disclosure is also directed to methods of making patterned spunbond fibrous webs. In exemplary embodiments, the methods include forming a plurality of filaments with a spunbonding process, capturing a population of the filaments in an identifiable pattern on a patterned collector surface, and bonding at least a portion of the filaments together without the use of an adhesive prior to removal of the web from the patterned collector surface, thereby causing the fibrous web to retain the identifiable pattern. In some exemplary embodiments, the method further comprises attenuating at least some of the filaments before capturing the population of the filaments on the patterned collector surface. In certain exemplary embodiments, bonding comprises one or more of autogenous thermal bonding, non-autogenous thermal bonding, and ultrasonic bonding. In particular exemplary embodiments, at least a portion of the filaments is oriented in a direction determined by the pattern. Suitable melt spinning or spunbonding processes, attenuation methods and apparatus, and bonding methods and apparatus (including autogenous bonding methods) are described in U.S. Pat. Pub. No. 2008/0026661 (Fox et al.).

1. Apparatus for Forming Patterned Spunbond Fibrous Webs

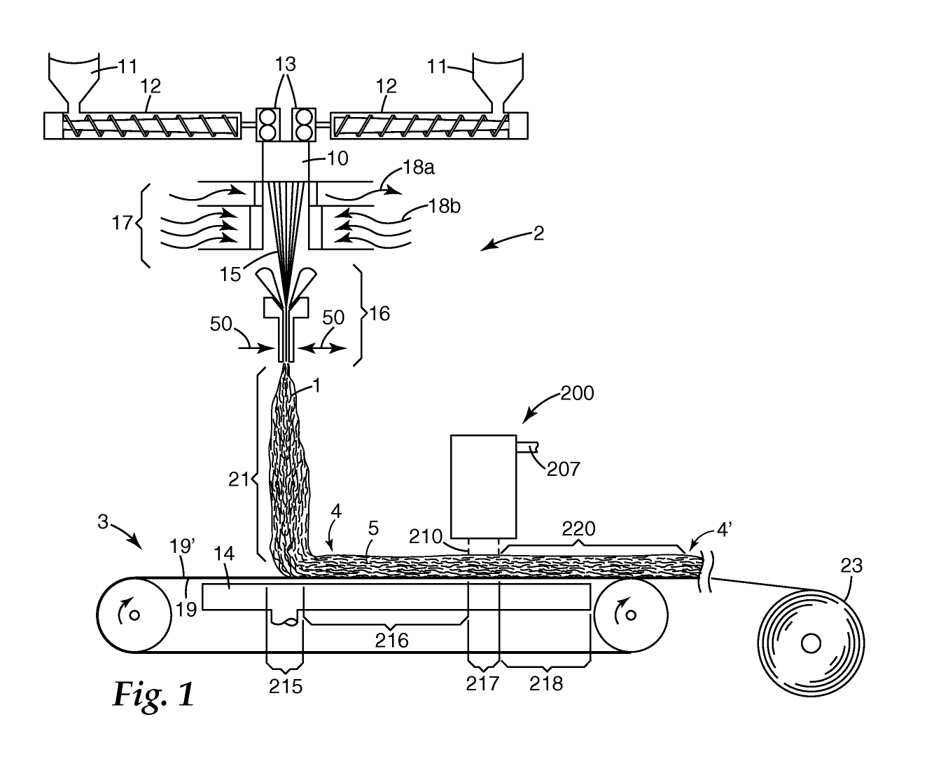

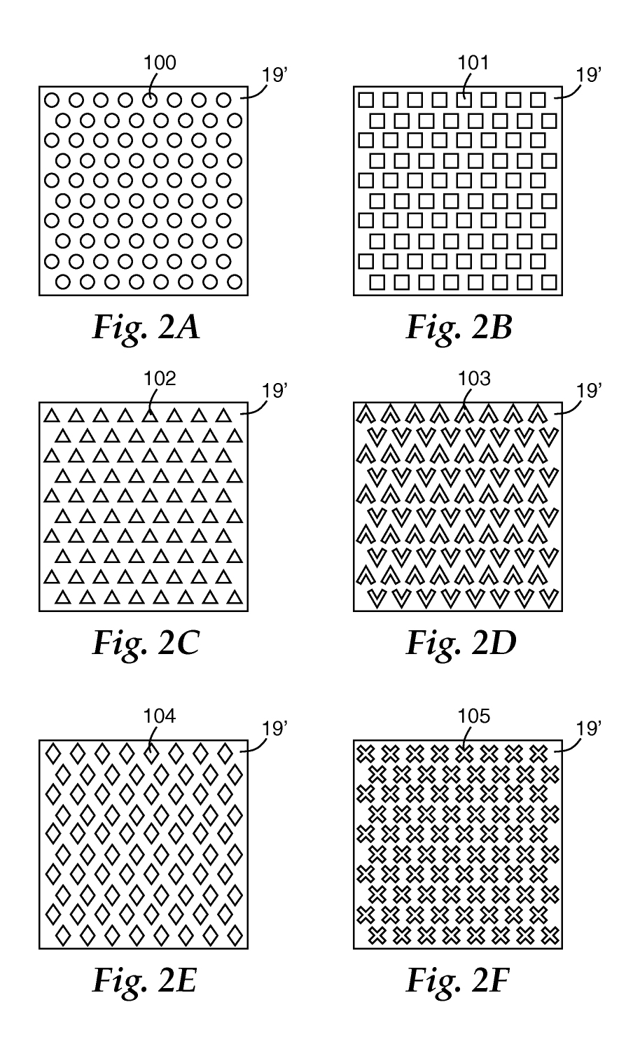

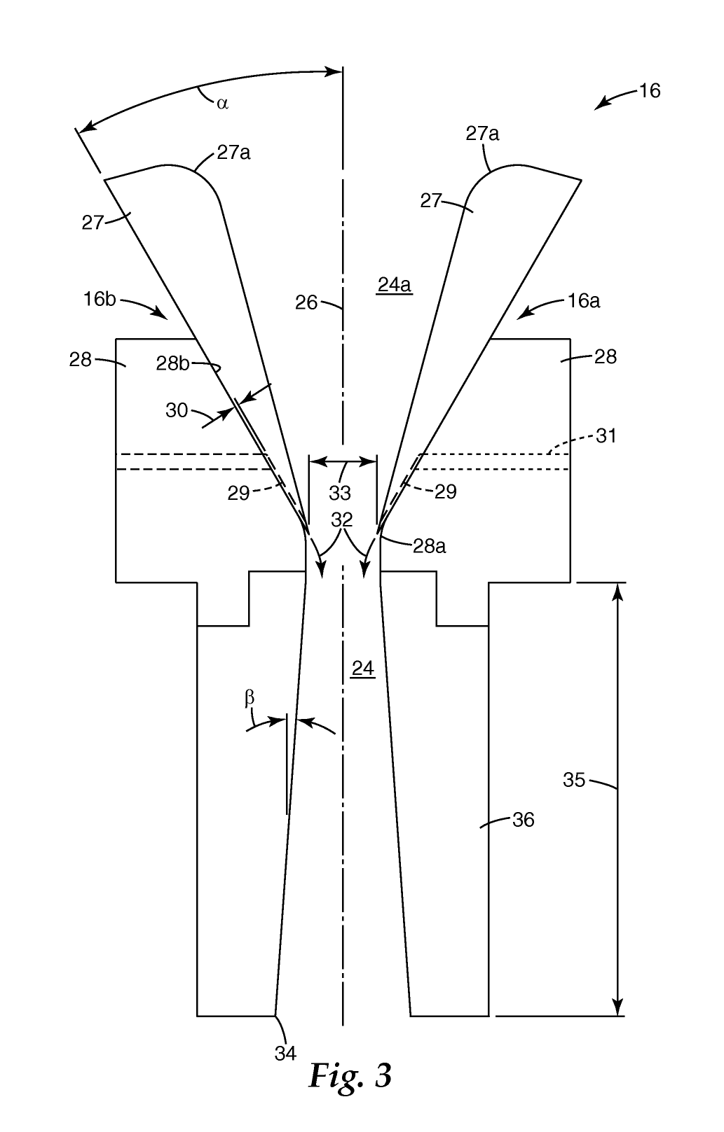

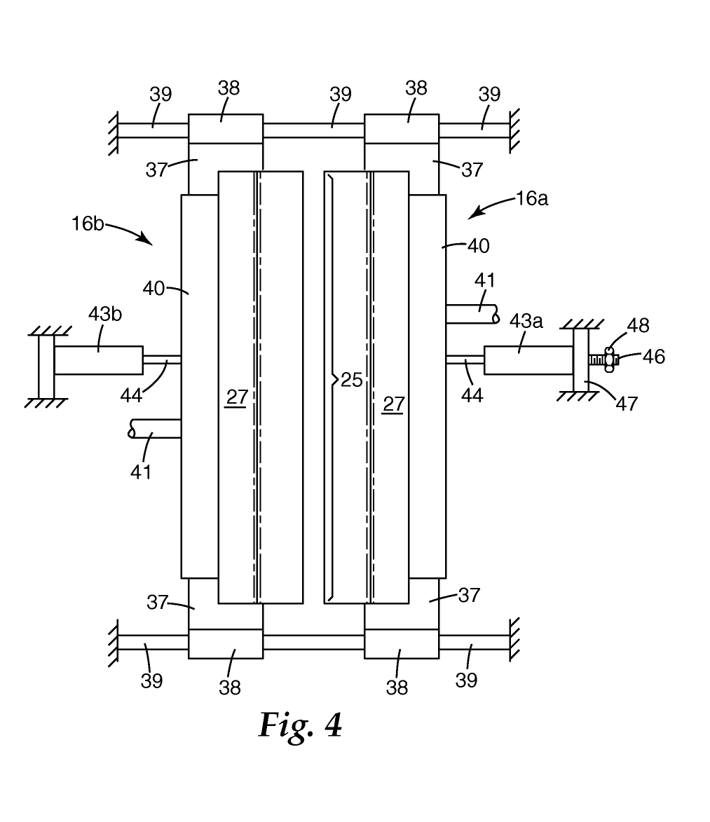

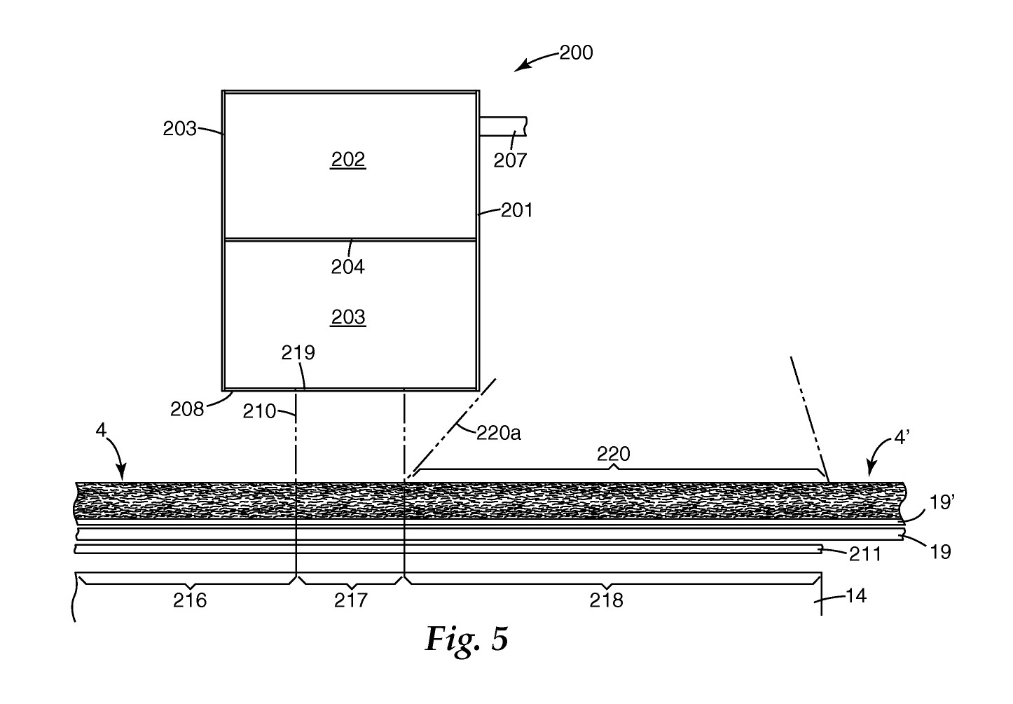

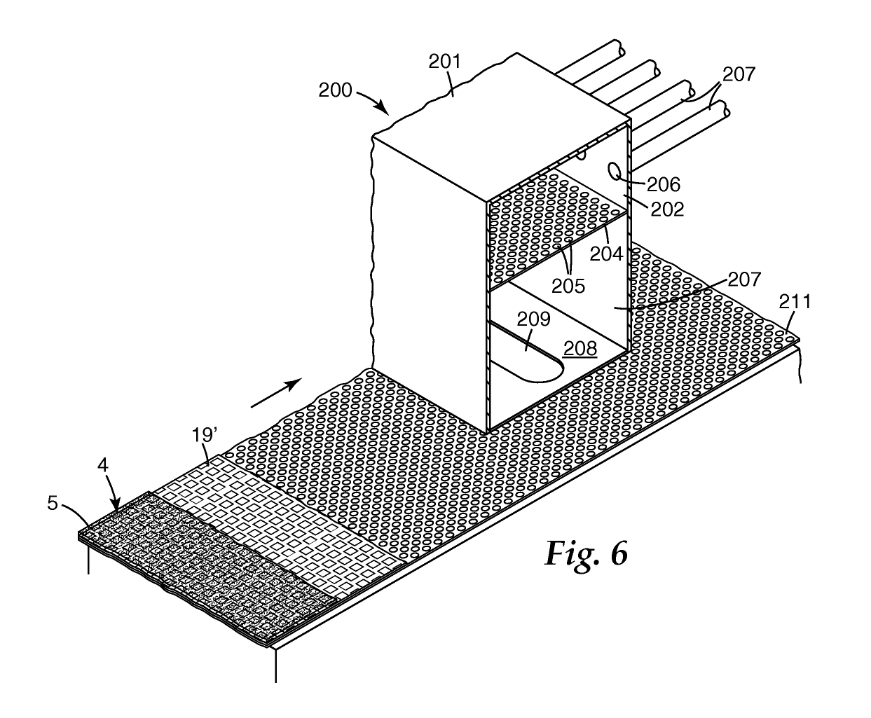

FIGS. 1-6 show an illustrative apparatus for carrying out various embodiments of the disclosure as part of an exemplary apparatus for forming a patterned spunbond fibrous web. FIG. 1 is a schematic overall side view of the apparatus. FIGS. 2A-2F are top views of various exemplary perforated patterned collector surfaces useful in forming a patterned spunbond fibrous web according to certain illustrative embodiments of the present disclosure. FIGS. 3 and 4 are enlarged views of an optional filament attenuating portion of the apparatus of FIG. 1. FIGS. 5 and 6 are enlarged views of an optional filament bonding portion of the apparatus shown in FIG. 1.

In one exemplary embodiments, a spunbond nonwoven fibrous web 5 having a two- or three-dimensional patterned surface 4′ may be formed by capturing melt spun filaments 15 on a patterned collector surface 19′ and bonding the filaments without an adhesive while on the collector 19, for example, by thermally bonding the filaments on the collector 19 under a through-air bonder 200. As shown in FIGS. 1-2, the collector 19 is generally porous (e.g., perforated) and a gas-withdrawal device 14 can be positioned below the collector to assist deposition of filaments onto the collector. The spunbond web 5 having a pattern 4′ maintained by the bonded filaments 15, may be wound up in a roll 23.

As generally illustrated in FIG. 1, a stream 15 of continuous melt spun filaments is prepared in filament-forming apparatus 2 and directed toward collection apparatus 3. The stream of continuous melt spun filaments 15 is collected in the form of a patterned fibrous melt spun web 5 having a patterned surface 4 on a patterned surface 19′ of collector 19, which is illustrated as a continuous or endless belt collector. Although the patterned surface 4 of the patterned fibrous melt spun web 5 is shown opposite the a top surface distal from the patterned surface 19′ of collector 19 in FIG. 1, it will be understood that in an alternative embodiment (not shown in the figures), the patterned surface of the patterned fibrous melt spun web may contact the patterned surface of the collector.

Exemplary embodiments of the presently disclosed invention may be practiced by collecting the patterned fibrous web 5 on a continuous screen-type collector such as the belt-type collector 19 as shown in FIG. 1, on a perforated template or stencil (see FIG. 2) bearing a surface pattern corresponding to the perforations and overlaying at least a portion of a porous or perforated collector (e.g. the screen-type collector of FIG. 1), or on a screen-covered drum (not shown), or using alternative methods known in the art.

The filament-forming apparatus 2 in FIG. 1 is one exemplary apparatus for use in practicing certain embodiments of the present disclosure. In using this apparatus, filament-forming material is brought to an extrusion head 10 in this illustrative apparatus, for example, by introducing a polymeric filament-forming material into a hopper 11, melting the material in an extruder 12, and pumping the molten material into the extrusion head 10 through a pump 13. Although solid polymeric material in pellet or other particulate form is most commonly used and melted to a liquid, pumpable state, other filament-forming liquids such as polymer solutions can also be used.

The extrusion head 10 may be a conventional spinnerette or spin pack, generally including multiple orifices arranged in a regular pattern, e.g., straightline rows. Filaments 15 of filament-forming liquid are extruded from the extrusion head and conveyed to a processing chamber or optional attenuator 16. The distance 17 the extruded filaments 15 travel before reaching the optional attenuator 16 can vary, as can the conditions to which they are exposed. Typically, quenching streams 18 of air or other gas are presented to the extruded filaments to reduce the temperature of the extruded filaments 15. Alternatively, the streams of air or other gas may be heated to facilitate drawing of the filaments.

In some exemplary embodiments, there may be one or more streams of air or other fluid, for example, a first air stream 18a blown transversely to the filament stream, which may remove undesired gaseous materials or fumes released during extrusion; and a second quenching air stream 18b that achieves a major desired temperature reduction. Additional quenching streams may be used; for example, the stream shown as 18b in FIG. 1 could itself comprise more than one stream to achieve a desired level of quenching. Depending on the process being used or the form of finished product desired, the quenching air may be sufficient to solidify the extruded filaments 15 before they reach the optional attenuator 16. In other cases the extruded filaments are still in a softened or molten condition when they enter the optional attenuator. Alternatively, no quenching streams are used; in such a case ambient air or other fluid between the extrusion head 10 and the optional attenuator 16 may be a medium for any change in the extruded filaments before they enter the optional attenuator.

2. Patterned Collector Surface for Forming Patterned Spunbond Fibrous Webs

As shown in FIGS. 1 and 2A-2F, in some exemplary embodiments, the patterned collector surface 19′ comprises a plurality of geometrically shaped perforations 100-105 extending through the collector 19, and capturing the population of filaments comprises drawing a vacuum through the perforated patterned collector surface. It will be understood that while an integral collector with a perforated patterned surface is shown in FIG. 1, other implementations, for example, a perforated patterned stencil or template positioned on a porous or perforated screen or belt, may be used as well.

In some exemplary embodiments, the plurality of geometrically shaped perforations have a shape selected from the group consisting of circular (FIG. 2A; 100), oval (not shown), polygonal (FIGS. 2B-2C and 2E; 101-102 and 104), V-shape (FIG. 2D; 103), X-shape (FIG. 2F; 105), and combinations thereof (not shown). In certain exemplary embodiments, the plurality of geometrically shaped perforations may have a polygonal shape selected from the group consisting of square (FIG. 2B; 101), rectangular (not shown), triangular (FIG. 2C; 102), diamond (FIG. 2E; 104); trapezoidal (not shown), pentagonal (not shown), hexagonal (not shown), octagonal (not shown), and combinations thereof (not shown).

In additional exemplary embodiments illustrated by FIGS. 2A-2F, the plurality of geometrically shaped perforations comprises a two-dimensional pattern on the patterned collector surface. In particular exemplary embodiments, the two-dimensional pattern of geometrically shaped perforations on the patterned collector surface is a two-dimensional array, as illustrated by FIGS. 2A-2F.

3. Optional Attenuator for Producing Patterned Spunbond Fibrous Webs

Optionally, in some embodiments illustrated by FIG. 1, the filaments 15 may pass through an optional attenuator 16, and eventually exit onto the collector 19 where they are collected as a patterned fibrous web 5, as discussed above. The distance 21 between the optional attenuator exit and the collector may be varied to obtain different effects. For example, moving the attenuator relative to the collector, or changing the air flow rate through the attenuator, may be advantageously used to increase or decrease the local basis weight of filaments in the patterned spunbond fibrous web. Operating the attenuator at a greater distance from the collector or at a lower air flow rate generally reduces the fraction of fibers collected in the perforations of the patterned collector surface, thereby reducing the local basis weight. In addition, the local basis weight of the patterned spunbond fibrous web may be varied in the machine direction (i.e. down-web) and/or in the traverse (i.e. cross-web) direction.

In the optional attenuator the filaments are lengthened and reduced in diameter and polymer molecules in the filaments become oriented, i.e., at least portions of the polymer molecules within the filaments become aligned with the longitudinal axis of the filaments. In the case of semi-crystalline polymers, the orientation is generally sufficient to develop strain-induced crystallinity, which greatly strengthens the resulting filaments. FIG. 3 is an enlarged side view of a representative optional attenuator 16 for preparing spunbond filaments that are especially useful in webs of the present disclosure. The optional attenuator 16 comprises two movable halves or sides 16a and 16b separated so as to define between them the processing chamber 24: the facing surfaces of the sides 16a and 16b form the walls of the chamber. FIG. 4 is a top and somewhat schematic view at a different scale showing the representative optional attenuator 16 and some of its mounting and support structure. As seen from the top view in FIG. 4, the processing (attenuation) chamber 24 (as shown in FIG. 3) is generally an elongated slot, having a transverse length 25 (transverse to the path of travel of filaments through the optional attenuator).

Although existing as two halves or sides, the optional attenuator functions as one unitary device and will be first discussed in its combined form. (The structure shown in FIGS. 3 and 4 is representative only, and a variety of different constructions may be used.) The representative optional attenuator 16 includes slanted entry walls 27, which define an entrance space or throat 24a of the attenuation chamber 24. The entry walls 27 preferably are curved at the entry edge or surface 27a to smooth the entry of air streams carrying the extruded filaments 15 (not shown in FIGS. 3-4). The walls 27 are attached to a main body portion 28, and may be provided with a recessed area 29 to establish a gap 30 between the body portion 28 and wall 27. Air (represented by the arrows) may be introduced into the gaps 30 through conduits 31, creating air knives 32 that increase the velocity of the filaments traveling through the optional attenuator, and that also have a further quenching effect on the filaments. The optional attenuator body 28 is preferably curved at 28a to smooth the passage of air from the air knife 32 into the passage 24. The angle (α) of the surface 28b of the optional attenuator body can be selected to determine the desired angle at which the air knife impacts a stream of filaments passing through the optional attenuator. Instead of being near the entry to the chamber, the air knives may be disposed further within the chamber.

FIG. 3 illustrates one exemplary optional attenuation chamber that may be useful in practicing embodiments of the present disclosure; other configurations may be used. The optional attenuator 16 may comprise an attenuation chamber 24 that may have a uniform gap width (the horizontal distance 33 on the page of FIG. 3 between the two optional attenuator sides is herein called the gap width) over its longitudinal length through the optional attenuator (the dimension along a longitudinal axis 26 through the attenuation chamber is called the axial length). Alternatively, as illustrated in FIG. 3, the gap width may vary along the length of the optional attenuator chamber. In a different embodiment, the attenuation chamber is defined by straight or flat walls; in such embodiments the spacing between the walls may be constant over their length, or alternatively the walls may slightly diverge or converge (preferred because it tends to cause a widening of the microfilament stream) over the axial length of the attenuation chamber. In all these cases, the walls defining the attenuation chamber are regarded as parallel herein, because the deviation from exact parallelism is relatively slight. As illustrated in FIG. 3, the walls defining the main portion of the longitudinal length of the passage 24 may take the form of plates 36 that are separate from, and attached to, the main body portion 28.

The length of the attenuation chamber 24 can be varied to achieve different effects; variation is especially useful with the portion between the air knives 32 and the exit opening 34, sometimes called herein the chute length 35. The angle between the chamber walls and the axis 26 may be wider near the exit 34 to change the distribution of filaments onto the collector; or structure such as deflector surfaces, curved surfaces exhibiting the Coanda effect, and uneven wall lengths may be used at the exit to achieve a desired spreading or other distribution of filaments. In general, the gap width, chute length, attenuation chamber shape, etc. are chosen in conjunction with the material being processed and the mode of treatment desired to achieve desired effects. For example, longer chute lengths may be useful to increase the crystallinity of prepared filaments. Conditions are chosen and can be widely varied to process the extruded filaments into a desired filament form.

As illustrated in FIG. 4, the two sides 16a and 16b of the representative optional attenuator 16 are each supported through mounting blocks 37 attached to linear bearings 38 that slide on rods 39. The bearing 38 has a low-friction travel on the rod through means such as axially extending rows of ball-bearings disposed radially around the rod, whereby the sides 16a and 16b can readily move toward and away from one another.

In this illustrative embodiment, air cylinders 43a and 43b are connected, respectively, to the optional attenuator sides 16a and 16b through connecting rods 44 and apply a clamping force pressing the optional attenuator sides 16a and 16b toward one another. Some useful modes of operation of the optional attenuator 16 are described in U.S. Pat. No. 6,607,624 (Berrigan et al.). For example, movement of the optional attenuator sides or chamber walls may occur when there is a perturbation of the system, such as when a filament being processed breaks or tangles with another filament or filament.

As will be seen, in the optional attenuator 16 illustrated in FIGS. 1, 3 and 4, there are no side walls at the ends of the transverse length of the chamber. The result is that filaments passing through the chamber can spread outwardly outside the chamber as they approach the exit of the chamber. Such a spreading can be desirable to widen the mass of filaments collected on the collector. In other embodiments, the processing chamber does include side walls, though a single side wall at one transverse end of the chamber is not attached to both chamber sides 16a and 16b, because attachment to both chamber sides would prevent separation of the sides as discussed above. Instead, a sidewall(s) may be attached to one chamber side and move with that side when and if it moves in response to changes of pressure within the passage. In other embodiments, the side walls are divided, with one portion attached to one chamber side, and the other portion attached to the other chamber side, with the sidewall portions preferably overlapping if it is desired to confine the stream of processed filaments within the processing chamber.

Although the apparatus shown in FIGS. 3-4 with movable walls has advantages as described, use of such an optional attenuator is not necessary to practice all embodiments of the presently described invention. Filaments useful in certain exemplary embodiments of the presently described invention may be prepared on apparatus in which the walls of the optional attenuator are fixed and unmovable, or do not move in practice.

Various processes conventionally used as adjuncts to filament-forming processes may be used in connection with filaments as they enter or exit from the optional attenuator, such as spraying of finishes or other materials onto the filaments, application of an electrostatic charge to the filaments, application of water mists, etc. In addition, various materials may be added to a patterned collected web, including bonding agents, adhesives, finishes, and other webs or films.

4. Optional Bonding Apparatus for Producing Patterned Spunbond Fibrous Webs

Depending on the condition of the filaments, some bonding may occur between the filaments during collection. However, further bonding between the spunbond filaments in the collected web may be needed or desirable to bond the filaments together in a manner that retains the pattern formed by the collector surface. “Bonding the filaments together” means adhering the filaments together firmly without an additional adhesive material, so that the filaments generally do not separate when the web is subjected to normal handling).

In some embodiments where light autogenous bonding provided by through-air bonding may not provide the desired web strength for peel or shear performance, it may be useful to incorporate a secondary or supplemental bonding step, for example, point bonding calendering, after removal of the patterned spunbond fibrous web from the collector surface. Other methods for achieving increased strength may include extrusion lamination or polycoating of a film layer onto the back (i.e., non-patterned) side of the patterned spunbond fibrous web, or bonding the patterned spunbond fibrous web to a support web (e.g., a conventional spunbond web, a nonporous film, a porous film, a printed film, or the like). Virtually any bonding technique may be used, for example, application of one or more adhesives to one or more surfaces to be bonded, ultrasonic welding, or other thermal bonding methods able to form localized bond patterns, as known to those skilled in the art. Such supplemental bonding may make the web more easily handled and better able to hold its shape.

Conventional bonding techniques using heat and pressure applied in a point-bonding process or by smooth calender rolls may also be used, though such processes may cause undesired deformation of filaments or compaction of the web. An alternate technique for bonding the spunbond filaments is through-air bonding as disclosed in U.S. Pat. Pub. No. 2008/0038976 (Berrigan et al.). An exemplary apparatus for performing through-air bonding (e.g. a through-air bonder) is illustrated in FIGS. 5 and 6 of the drawings.

As shown in FIGS. 5-6, patterned spunbond nonwoven fibrous webs 5 having a two- or three-dimensional patterned surface 4 may be formed by capturing melt spun filaments on a patterned collector surface 19′ and bonding the filaments without an adhesive while on the collector 19, for example, by thermally bonding the filaments without use of an adhesive while on the collector 19 under a through-air bonder 200. As applied to the present disclosure, the presently preferred through-air bonding technique involves subjecting the collected patterned web of spunbond filaments to a controlled heating and quenching operation that includes a) forcefully passing through the web a gaseous stream heated to a temperature sufficient to soften the spunbond filaments sufficiently to cause the spunbond filaments to bond together at points of filament intersection (e.g., at sufficient points of intersection to form a coherent or bonded matrix), the heated stream being applied for a discrete time too short to wholly melt the filaments, and b) immediately forcefully passing through the web a gaseous stream at a temperature at least 50° C. less than the heated stream to quench the filaments (as defined in the above-mentioned U.S. Pat. Pub. No. 2008/0038976 (Berrigan et al.), “forcefully” means that a force in addition to normal room pressure is applied to the gaseous stream to propel the stream through the web; “immediately” means as part of the same operation, i.e., without an intervening time of storage as occurs when a web is wound into a roll before the next processing step). As a shorthand term this technique is described as the quenched flow heating technique, and the apparatus as a quenched flow heater.

A variation of the described method, taught in more detail in the aforementioned U.S. Pat. Pub. No. 2008/0038976 (Berrigan et al.), takes advantage of the presence of two different kinds of molecular phases within spunbond filaments—one kind called crystallite-characterized molecular phases because of a relatively large presence of chain-extended, or strain-induced, crystalline domains, and a second kind called amorphous-characterized phases because of a relatively large presence of domains of lower crystalline order (i.e., not chain-extended) and domains that are amorphous, though the latter may have some order or orientation of a degree insufficient for crystallinity.

These two different kinds of phases, which need not have sharp boundaries and can exist in mixture with one another, have different kinds of properties, including different melting and/or softening characteristics: the first phase characterized by a larger presence of chain-extended crystalline domains melts at a temperature (e.g., the melting point of the chain-extended crystalline domain) that is higher than the temperature at which the second phase melts or softens (e.g., the glass transition temperature of the amorphous domain as modified by the melting points of the lower-order crystalline domains).

In the stated variation of the described method, heating is at a temperature and for a time sufficient for the amorphous-characterized phase of the filaments to melt or soften while the crystallite-characterized phase remains unmelted. Generally, the heated gaseous stream is at a temperature greater than the onset melting temperature of the polymeric material of the filaments. Following heating, the web is rapidly quenched as discussed above.

Treatment of the collected web at such a temperature is found to cause the spunbond filaments to become morphologically refined, which is understood as follows (we do not wish to be bound by statements herein of our “understanding,” which generally involve some theoretical considerations). As to the amorphous-characterized phase, the amount of molecular material of the phase susceptible to undesirable (softening-impeding) crystal growth is not as great as it was before treatment. The amorphous-characterized phase is understood to have experienced a kind of cleansing or reduction of molecular structure that would lead to undesirable increases in crystallinity in conventional untreated filaments during a thermal bonding operation. Treated filaments of certain exemplary embodiments of the presently described invention may be capable of a kind of “repeatable softening,” meaning that the filaments, and particularly the amorphous-characterized phase of the filaments, will undergo to some degree a repeated cycle of softening and resolidifying as the filaments are exposed to a cycle of raised and lowered temperature within a temperature region lower than that which would cause melting of the whole filament.

In practical terms, repeatable softening is indicated when a treated web (which already generally exhibits a useful bonding as a result of the heating and quenching treatment) can be heated to cause further autogenous bonding of the filaments. The cycling of softening and resolidifying may not continue indefinitely, but it is generally sufficient that the filaments may be initially bonded by exposure to heat, e.g., during a heat treatment according to certain exemplary embodiments of the presently described invention, and later heated again to cause re-softening and further bonding, or, if desired, other operations, such as calendering or re-shaping. For example, a web may be calendered to a smooth surface or given a nonplanar shape, e.g., molded into a face mask, taking advantage of the improved bonding capability of the filaments (though in such cases the bonding is not limited to autogenous bonding).

While the amorphous-characterized, or bonding, phase has the described softening role during web-bonding, calendering, shaping or other like operation, the crystallite-characterized phase of the filament also may have an important role, namely to reinforce the basic filament structure of the filaments. The crystallite-characterized phase generally can remain unmelted during a bonding or like operation because its melting point is higher than the melting/softening point of the amorphous-characterized phase, and it thus remains as an intact matrix that extends throughout the filament and supports the filament structure and filament dimensions.

Thus, although heating the web in an autogenous bonding operation may cause filaments to weld together by undergoing some flow and coalescence at points of filament intersection, the basic discrete filament structure is substantially retained over the length of the filaments between intersections and bonds; preferably, the cross-section of the filaments remains unchanged over the length of the filaments between intersections or bonds formed during the operation. Similarly, although calendering of a web may cause filaments to be reconfigured by the pressure and heat of the calendering operation (thereby causing the filaments to permanently retain the shape pressed upon them during calendering and make the web more uniform in thickness), the filaments generally remain as discrete filaments with a consequent retention of desired web porosity, filtration, and insulating properties.

As shown in FIGS. 5 and 6, in an exemplary method of carrying out certain exemplary embodiments of the present disclosure, a formed spunbond fibrous web 5 having a patterned surface 4 formed on the patterned collector surface 19′, is carried by the moving collector 19 (see FIG. 1) under a controlled-heating device 200 mounted above the collector 19 (see FIG. 1). The exemplary heating device 200 comprises a housing 201 which is divided into an upper plenum 202 and a lower plenum 203. The upper and lower plenums are separated by a plate 204 perforated with a series of holes 205 that are typically uniform in size and spacing. A gas, typically air, is fed into the upper plenum 202 through openings 206 (FIG. 6) from conduits 207, and the plate 204 functions as a flow-distribution means to cause air fed into the upper plenum to be rather uniformly distributed when passed through the plate into the lower plenum 203. Other useful flow-distribution means include fins, baffles, manifolds, air dams, screens or sintered plates, i.e., devices that even the distribution of air.

In the illustrative heating device 200 the bottom wall 208 of the lower plenum 203 is formed with an elongated slot 209 through which an elongated or knife-like stream 210 of heated air from the lower plenum is blown onto the patterned surface 4 of the melt spun fibrous web 5 traveling on the collector 19 below the heating device 200 (the patterned spunbond fibrous web 5 and collector 19 are shown as a partial cut-away in FIG. 6). The air-exhaust device 14 preferably extends sufficiently to lie under the slot 209 of the heating device 200 (as well as extending downweb a distance 218 beyond the heated stream 210 and through an area marked 220, as will be discussed below). Heated air in the plenum is thus under an internal pressure within the plenum 203, and at the slot 209 it is further under the exhaust vacuum of the air-exhaust device 14. To further control the exhaust force a perforated plate 211 may be positioned under the collector 19 (see FIG. 1) to impose a kind of back pressure or flow-restriction means that assures the stream 210 of heated air will spread to a desired extent over the width or heated area of the collected patterned spunbond fibrous web 5 and be inhibited in streaming through possible lower-density portions of the collected mass. Other useful flow-restriction means include screens or sintered plates.

The number, size and density of openings in the plate 211 may be varied in different areas to achieve desired control. Large amounts of air pass through the microfilament-forming apparatus and must be disposed of as the filaments reach the collector in the region 215 (see FIG. 1). Sufficient air passes through the web and collector in the region 216 to hold the web in place under the various streams of processing air. And sufficient openness is needed in the plate under the heat-treating region 217 to allow treating air to pass through the web, while sufficient resistance is provided to assure that the air is evenly distributed.

In general, by controlling the temperature and velocity of the air exiting the through-air bonder, the level of autogenous bonding between the filaments that form the patterned spunbond fibrous web may be controlled. Preferably, the air flow and temperature are adjusted to allow the patterned spunbond fibrous web to be removed from the patterned collector surface without destroying the two-dimensional or three-dimensional surface pattern formed by contact with the patterned surface of the collector. However, it will be understood that there are potential advantages associated with the ability to vary the autogenous bonding level over a wide range from low bonding to high bonding level. For example, at high bonding levels, the filaments may form a stable three-dimensional structure that may allow the patterned spunbond fibrous web to be more easily handled. At lower bonding levels, the patterned spunbond fibrous web may exhibit higher extension (e.g. stretch), and may also be more readily thermally laminated to other layers without using temperatures exceeding the crystalline melting point of the material (e.g. a (co)polymer) making up the filaments.

Thus in certain exemplary embodiments, the temperature and exposure time conditions of the patterned spunbond fibrous web are carefully controlled. In certain exemplary embodiments, the temperature-time conditions may be controlled over the whole heated area of the mass. We have obtained best results when the temperature of the stream 210 of heated air passing through the web is within a range of 5° C., and preferably within 2 or even 1° C., across the width of the mass being treated (the temperature of the heated air is often measured for convenient control of the operation at the entry point for the heated air into the housing 201, but it also can be measured adjacent the collected web with thermocouples). In addition, the heating apparatus is operated to maintain a steady temperature in the stream over time, e.g., by rapidly cycling the heater on and off to avoid over- or under-heating. Preferably the temperature is held within one degree Centigrade of the intended temperature when measured at one second intervals.

To further control heating, the mass is subjected to quenching quickly after the application of the stream 210 of heated air. Such a quenching can generally be obtained by drawing ambient air over and through the patterned spunbond fibrous web 5 immediately after the mass leaves the controlled hot air stream 210. Numeral 220 in FIG. 5 represents an area in which ambient air is drawn through the patterned web by the air-exhaust device after the web has passed through the hot air stream. Actually, such air can be drawn under the base of the housing 201, e.g., in the area 220a marked on FIG. 6 of the drawings, so that it reaches the web almost immediately after the web leaves the hot air stream 210. And the air-exhaust device 14 extends along the collector for a distance 218 beyond the heating device 200 to assure thorough cooling and quenching of the whole patterned spunbond fibrous web 5. For shorthand purposes the combined heating and quenching apparatus is termed a quenched flow heater.

One aim of the quenching is to withdraw heat before undesired changes occur in the spunbond filaments contained in the web. Another aim of the quenching is to rapidly remove heat from the web and the filaments and thereby limit the extent and nature of crystallization or molecular ordering that will subsequently occur in the filaments. By rapid quenching from the molten/softened state to a solidified state, the amorphous-characterized phase is understood to be frozen into a more purified crystalline form, with reduced molecular material that can interfere with softening, or repeatable softening, of the filaments. For some purposes, quenching may not be absolutely required though it is strongly preferred for most purposes.

To achieve quenching the mass is desirably cooled by a gas at a temperature at least 50° C. less than the nominal melting point; also the quenching gas is desirably applied for a time on the order of at least one second (the nominal melting point is often stated by a polymer supplier; it can also be identified with differential scanning calorimetry, and for purposes herein, the “Nominal Melting Point” for a polymer is defined as the peak maximum of a second-heat, total-heat-flow DSC plot in the melting region of a polymer if there is only one maximum in that region; and, if there are more than one maximum indicating more than one melting point (e.g., because of the presence of two distinct crystalline phases), as the temperature at which the highest-amplitude melting peak occurs). In any event the quenching gas or other fluid has sufficient heat capacity to rapidly solidify the filaments.

In an alternative embodiment particularly useful for materials that do not form autogenous bonds to a significant extent, melt spun filaments may be collected on a patterned surface of a collector and one or more additional layer(s) of fibrous material capable of bonding to the filaments may be applied on, over or around the filaments, thereby bonding together the filaments before the filaments are removed from the collector surface.

The additional layer(s) could be, for example, one or more meltblown layers, or one or more extrusion laminated film layer(s). The layer(s) would not need to be physically entangled, but would generally need some level of interlayer bonding along the interface between layer(s). In such embodiments, it may not be necessary to bond together the filaments using through-air bonding in order to retain the pattern on the surface of the patterned spunbond fibrous web.

5. Optional Processing Steps for Producing Patterned Spunbond Fibrous Webs

In preparing spunbond filaments according to various embodiments of the present disclosure, different filament-forming materials may be extruded through different orifices of a meltspinning extrusion head so as to prepare webs that comprise a mixture of filaments. Various procedures are also available for electrically charging a nonwoven fibrous web to enhance its filtration capacity: see, e.g., U.S. Pat. No. 5,496,507 (Angadjivand).

In addition to the foregoing methods of making a patterned spunbond fibrous web, one or more of the following process steps may be carried out on the web once formed:

(1) advancing the patterned spunbond fibrous web along a process pathway toward further processing operations;

(2) bringing one or more additional layers into contact with an outer surface of the patterned spunbond fibrous web;

(3) calendering the patterned spunbond fibrous web;

(4) coating the patterned spunbond fibrous web with a surface treatment or other composition (e.g., a fire retardant composition, an adhesive composition, or a print layer);

(5) attaching the patterned spunbond fibrous web to a cardboard or plastic tube;

(6) winding-up the patterned spunbond fibrous web in the form of a roll;

(7) slitting the patterned spunbond fibrous web to form two or more slit rolls and/or a plurality of slit sheets;

(8) placing the patterned spunbond fibrous web in a mold and molding the patterned spunbond fibrous web into a new shape;

(9) applying a release liner over an exposed optional pressure-sensitive adhesive layer, when present; and

(10) attaching the patterned spunbond fibrous web to another substrate via an adhesive or any other attachment device including, but not limited to, clips, brackets, bolts/screws, nails, and straps.

### C. Methods of Using Patterned Spunbond Fibrous Webs

The present disclosure is also directed to methods of using the patterned spunbond fibrous webs of the present disclosure in a variety of applications. In yet another aspect, the disclosure relates to articles comprising the composite nonwoven fibrous webs described above prepared according to the foregoing methods. Certain particular exemplary articles may be useful as a gas filtration article, a liquid filtration article, a sound absorption article, a thermal insulation article, a surface cleaning article, an abrasive article, a cellular growth support article, a drug delivery article, a personal hygiene article, and a wound dressing article.

For example, exemplary patterned spunbond fibrous webs of the present disclosure may be useful in providing a fluid distribution layer when used for gas or liquid filtration. Exemplary patterned spunbond fibrous webs of the present disclosure may provide additional surface area for thermal or acoustical dampening. Exemplary patterned spunbond fibrous webs of the present disclosure may provide a particularly effective textured surface for use in a wipe for surface cleaning, because the pattern may have the advantage of providing a reservoir for cleaning agents and high surface for trapping debris. Exemplary patterned spunbond fibrous webs of the present disclosure may be useful in providing a dust extraction layer in an abrasive article for use in a sanding operation. Exemplary patterned spunbond fibrous webs of the present disclosure may provide a scaffold for supporting cell growth, or an easily removable textured wound dressing material exhibiting less surface contact with the wound, and therefore being more readily removable and allowing the wound to breathe. In some applications, the unique orientation of the filaments as determined by the pattern may lead to selective wicking of fluids.

Exemplary patterned spunbond fibrous webs of the present disclosure may be particularly useful as a loop material for a hook-and-loop mechanical fastener or closure. In certain embodiments, a light bonding level obtained after through-air bonding may allow a hook to more easily penetrate the surface of a patterned spunbond fibrous web and engage with the loops formed by the filaments of the web.

### EXAMPLES

Exemplary embodiments have been described above and are further illustrated below by way of the following Examples, which are not to be construed in any way as imposing limitations upon the scope of the presently described invention. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims. Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Examples 1-4

Patterned surface collectors in the form of flexible, adhesive backed rubber sandblasting stencils, each stencil having a patterned surface in the form of a plurality of geometrically-shaped perforations as exemplified by FIGS. 2A-2F, were positioned on (and additionally taped to) the continuous belt screen 211 (FIG. 6) of the melt spinning apparatus exemplified by FIG. 1. The widths of the stencils were about 16 in (40.6 cm). The thicknesses of the sandblasting stencils, and depths of the perforations, were about 1.3 mm.

Using the apparatus illustrated by FIG. 1, melt spun filaments were formed from Total 3868 polypropylene (Total Petrochemicals U.S.A., Inc.). The polymer melt temperature was 235° C. The filament quench zone temperature was 40° C. with blower settings of 15 Hz in the upper zone and 8 Hz in the lower zone. The resulting filaments had a median diameter of 16 micrometers.

The filaments were collected on the patterned surface collector to form a patterned melt spun fibrous web having a width of 15 in (38.1 cm). The attenuator was set with a 0.2 inch (0.51 cm) gap, and operated at an air blower setting of 60%. The attenuator was positioned 5 in (12.7 cm) above the collector surface. The through-air bonder was operated at 143° C. and a blower setting of 60%, and was positioned 1.5 in (3.81 cm) above the surface of the patterned melt spun fibrous web. At this bonding temperature, the filaments formed sufficient bonds to permit removal of the patterned spunbond fibrous web from the collector surface as a self-supporting web after passing through the through-air bonder.

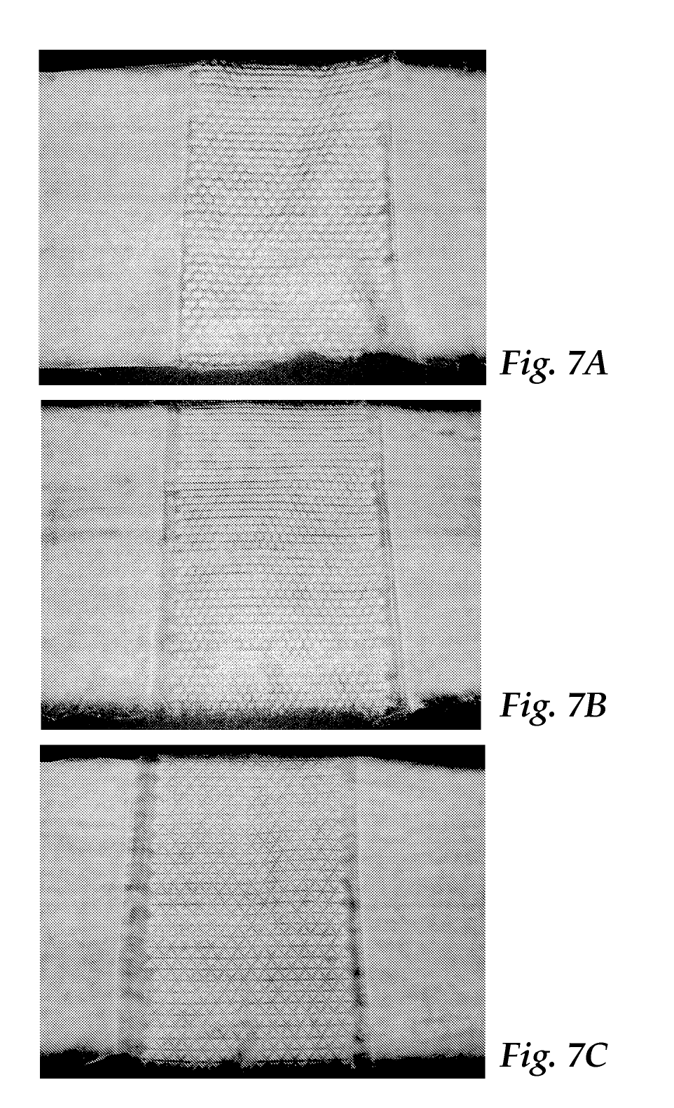

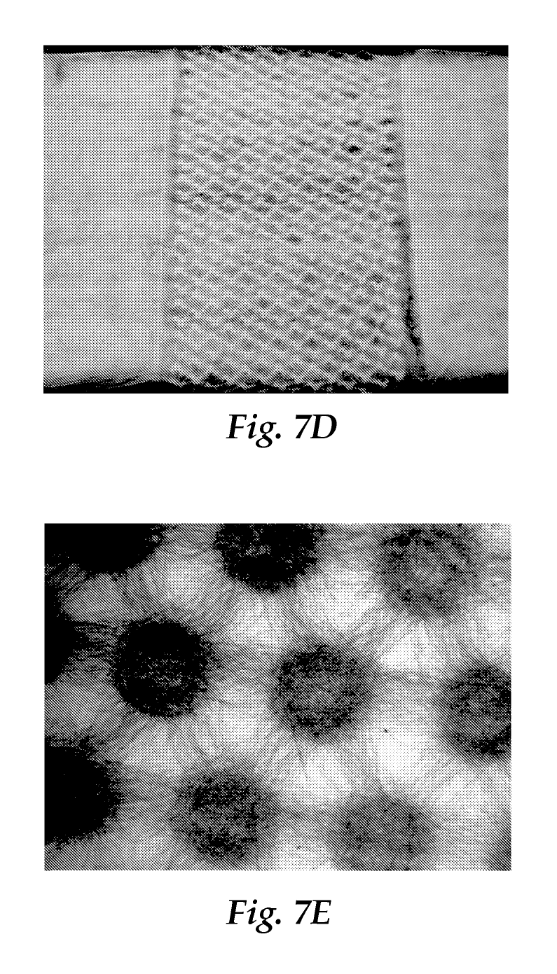

FIG. 7A shows an exemplary patterned spunbond fibrous web having an identifiable pattern in the form of an array of circles corresponding to the pattern on the collector surface, 0.25 in (0.64 cm) diameter circles with a pitch of 0.310 in (0.787 cm) and 60% perforated area. FIG. 7B shows an exemplary patterned spunbond fibrous web having an identifiable pattern in the form of an array of squares corresponding to the pattern on the collector surface, 0.222 in (0.564 cm) squares (on side) having a pitch (offset) of 0.289 in (0.734 cm). FIG. 7C shows an exemplary patterned spunbond fibrous web having an identifiable pattern in the form of an array of triangles corresponding to the pattern on the collector surface, equilateral triangles with a pitch of 0.438 in (1.113 cm). FIG. 7D shows an exemplary patterned spunbond fibrous web having an identifiable pattern in the form of V-shaped “birds” as generally illustrated by FIG. 2D.

### Example 5

Using the apparatus illustrated by FIG. 1, melt spun filaments were formed from Total 3868 polypropylene (Total Petrochemicals U.S.A., Inc.). The polymer melt temperature was 220° C., and the flow rate was 0.27 g/hole/min through a 648 hole die. The filament quench temperature was 40° C. with blower settings of 26 Hz in the upper zone and 9 Hz in the lower zone.

The filaments were collected on a patterned surface collector in the form of a 0.07 in (0.178 cm) thick metal plate having 0.375 in (0.953 cm) circular perforations arranged in a staggered array with a spacing between perforations of about 0.12 in (0.305 cm) to form a patterned melt spun fibrous web having a width of 21 in (53.34 cm). The perforated collector was positioned on the continuous belt screen 211 (FIG. 6) of the melt spinning apparatus exemplified by FIG. 1, and passed under the filament stream exiting the attenuator to collect the melt spun filaments as a patterned melt spun fibrous web on the patterned surface of the collector. The attenuator was set with a 0.02 inch (0.051 cm) gap, and operated at an air blower setting of 60% (yielding a restrictor pressure of 7 psig). The attenuator was positioned 7 in (16.8 cm) above the collector surface.

The filaments on the collector were passed under a through-air bonder operating at 155° C. The through-air bonder had a slot length of 22 in (55.88 cm), a slot width of 2.75 in (6.99 cm), and was positioned 1.5 in (3.81 cm) above the surface of the patterned melt spun fibrous web. At this bonding temperature, the filaments formed sufficient bonds to permit removal of the patterned spunbond fibrous web from the collector surface as a self-supporting web after passing through the through-air bonder.

FIG. 7E shows the resulting patterned spunbond fibrous web having an identifiable pattern in the form of an array of circles corresponding to the pattern on the collector surface. Note in particular the high degree of filament orientation in a direction determined by the pattern.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the presently described invention. Thus, the appearances of the phrases such as “in one or more embodiments,” “in certain embodiments,” “in one embodiment” or “in an embodiment” in various places throughout this specification are not necessarily referring to the same embodiment of the presently described invention. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term ‘about’. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. (canceled)

2. A fibrous web comprising:
a population of spunbond (co)polymeric filaments collected in an identifiable pattern and bonded together without an adhesive, wherein at least a portion of the filaments are oriented in a direction determined by the pattern.

3. (canceled)

4. The fibrous web of claim 2, wherein the (co)polymeric filaments comprise polypropylene, polyethylene, polyester, polyethylene terephthalate, polybutylene terephthalate, polyamide, polyurethane, polybutene, polylactic acid, polyvinyl alcohol, polyphenylene sulfide, polysulfone, liquid crystalline polymer, polyethylene-co-vinylacetate, polyacrylonitrile, cyclic polyolefin, polyoxymethylene, polyolefinic thermoplastic elastomers, or a combination thereof.

5. The fibrous web of claim 4, wherein the (co)polymeric filaments comprise polyolefin filaments.

6. The fibrous web of claim 2, wherein the population of spunbond filaments has a median filament diameter ranging from about 1 μm to about 100 μm.

7. (canceled)

8. The fibrous web of claim 2, wherein only a portion of each filament is bonded to one or more of the other filaments in the population of filaments.

9. The fibrous web of claim 2, wherein the identifiable pattern is a two-dimensional pattern.

10. The fibrous web of claim 9, wherein the two-dimensional pattern is an arrangement of geometric shapes selected from the group consisting of circles, ovals, polygons, X-shapes, V-shapes, and combinations thereof.

11. The fibrous web of claim 10, wherein the arrangement of geometric shapes is a two-dimensional array.

12. A method of making a fibrous web, comprising:
(a) forming a plurality of (co)polymeric filaments with a spunbonding process;
(b) capturing a population of the filaments in an identifiable pattern on a patterned collector surface, wherein the identifiable pattern corresponds to the patterned collector surface; and
(c) bonding at least a portion of the filaments together without the use of an adhesive prior to removal of the web from the patterned collector surface, thereby causing the fibrous web to retain the identifiable pattern.

13. The method of claim 12, further comprising attenuating at least some of the filaments before capturing the population of the filaments on the patterned collector surface.

14. The method of claim 12, wherein bonding comprises one or more of autogenous thermal bonding, non-autogenous thermal bonding, and ultrasonic bonding.

15. The method of claim 12, wherein at least a portion of the filaments is oriented in a direction determined by the pattern.

16. (canceled)

17. The method of claim 12, wherein the population of filaments has a median filament diameter ranging from about 1 μm to about 100 μm.

18. The method of claim 12, wherein the patterned collector surface comprises a plurality of geometrically shaped perforations extending through the collector, and further wherein capturing the population of filaments comprises drawing a vacuum through the perforated patterned collector surface.

19. The method of claim 18, wherein the plurality of geometrically shaped perforations have a shape selected from the group consisting of circular, oval, polygonal, X-shape, V-shape, and combinations thereof.

20. The method of claim 19, wherein the plurality of geometrically shaped perforations have a polygonal shape selected from the group consisting of triangular, square, rectangular, diamond, trapezoidal, pentagonal, hexagonal, octagonal, and combinations thereof.

21. The method of claim 18, wherein the plurality of geometrically shaped perforations comprises a two-dimensional pattern on the patterned collector surface.

22. The method of claim 21, wherein the two-dimensional pattern of geometrically shaped perforations on the patterned collector surface is a two-dimensional array.

23. An article comprising the fibrous web prepared according to the method of claim 12, selected from the group consisting of a gas filtration article, a liquid filtration article, a sound absorption article, a thermal insulation article, a surface cleaning article, an abrasive article, a cellular growth support article, a drug delivery article, a personal hygiene article, and a wound dressing article.

24. A hook and loop fastener comprising the patterned spunbond fibrous web according to claim 1, wherein the patterned spunbond fibrous web comprises a plurality of fibrous loops adapted to engage with a hooked fastener.
